(19) United States
(12) Patent Application Publication
(10) Pub. No.: US 2007/0062983 A1
(43) Pub. Date: Mar. 22, 2007

(54) Display case

(76) Inventors: Michael J. Barnett, Bakersfield, CA (US); Karen Barnett, Bakersfield, CA (US)

Correspondence Address: James M. Duncan, P.O. Box 11172, Bakersfield, CA, 93389-1172, US

(21) Appl. No.: 11/366,693

(22) Filed: Mar. 1, 2006

Related U.S. Application Data
(60) Provisional application No. 60/719,156, filed on Sep. 20, 2005.

(51) Int. Cl. A41H 5/00; B01D 53/02

(52) U.S. Cl. 223/69; 96/148

(57) ABSTRACT

A display case provides a mechanism for displaying a clothing article in an attractive setting while simultaneously protecting the clothing article. The display case comprises an enclosure comprising a plurality of panels, including an panel which opens to provide access to the interior of the display case. The display case further comprises a dress form disposed within the interior of the display case. Some of the panels comprise glass sections allowing a viewer to observe the clothing article within the enclosing frame. The display case further comprises an enclosing top and bottom. The display case comprises a floor upon which the dress form may be disposed, wherein a cavity is defined by the space between the enclosing bottom and the floor. The display case further comprises humidity control means which may be located within the cavity. One embodiment of the display case may comprise back panels wherein the back panels have mirrored surfaces on the interior side to reflect the back and sides of the clothing article. One embodiment of the display case may be shaped hexagonally.

### CROSS-REFERENCE TO RELATED APPLICATION

U.S. Provisional Application No. 60/719,156 for this invention was filed on Sep. 20, 2005 for which these inventors claim domestic priority.

### BACKGROUND OF THE INVENTION

The present invention generally relates to display cases. In particular, a display case for preserving and displaying various clothing articles, including wedding gowns and other clothing articles of high sentimental value is disclosed.

Various enclosed glass display cases are known for displaying different articles, including art work, flower arrangements, and athletic awards. See, for example, U.S. Pat. Nos. 3,697,147; 3,697,363; 4,141,610; 4,255,001; 4,304,447; 4,951,555; 5,175,726; 5,127,718; 6,024,775; and 6,158,828. With respect to glass display cases for displaying clothing articles, the '828 patent discloses a display frame for displaying a jersey, where the jersey is supported on a support member fixed to the frame body. However, while the '828 patent purports to display jerseys in a three dimensional realistic and life-like fashion, the support member is essentially a modified clothes hanger having greater thickness for giving the appearance of shoulder pads. The '828 patent does not disclose means for controlling the humidity and light, and appears only to provide protection by enclosing the jersey.

There are certain clothing articles which for many reasons, particularly sentimental, the owner wishes to preserve and safeguard. For example, great lengths may be taken to protect a woman's wedding gown. However, most means of preserving and protecting wedding gowns and other clothing articles make viewing the clothing article difficult at best. For example, viewing a wedding gown through a sealed garment bag hardly displays the gown in a manner having any similarity to the conditions in which the gown was originally worn.

Alternatively, if the clothing article is displayed in a more realistic fashion, the known display methods generally provide little protection to the clothing article. The use of dress forms and mannequins is well known for presenting clothing articles in a more realistic manner. However, simply displaying a clothing article using these items exposes the gown to the environment, and potentially places it in the path of children, pets, overly enthusiastic viewers, and anything they happen to be carrying. In addition, sunlight or other forms of ultraviolet radiation, lack of humidity, excessive humidity, insects, airborne contaminants, etc., will damage the fabric over time.

### SUMMARY OF THE INVENTION

The disclosed display case provides a mechanism for displaying a clothing article in an attractive setting while simultaneously protecting the clothing article. The display case comprises an enclosure comprising a plurality of panels, including an access panel which is hingedly attached to a frame. The article of clothing may be placed upon a dress form disposed within the enclosure. Some of the panels comprise glass sections allowing a viewer to observe the clothing article within the enclosing frame. The disclosed display case further comprises an enclosing top and bottom. The display case further comprises a floor upon which the dress form may be disposed. The display case further comprises means for controlling the humidity within the enclosure, and may also comprise lighting means for illuminating the clothing article. One embodiment of the display case may comprise back panels wherein the back panels have mirrored surfaces on the interior side to reflect the back and sides of the clothing article. One embodiment of the display case may be shaped hexagonally.

### BRIEF DESCRIPTION OF THE DRAWINGS

FIG. 1 depicts a perspective view of an embodiment of the disclosed display case, wherein a gown is mounted on the dress form.

FIG. 2 depicts the embodiment of FIG. 1, wherein the gown is removed from the dress form.

FIG. 3 depicts the embodiment of FIG. 2, wherein the dress form has been removed from the display case to better show other features of the embodiment.

FIG. 4 depicts a back view of an embodiment of the disclosed display case.

FIG. 5 depicts a bottom view of an embodiment of the disclosed display case.

FIG. 6 depicts a view of an embodiment of the disclosed display case showing how a humidistat, electrical junction box and electrical connectors may be mounted in a cavity at the bottom of the display case.

FIG. 7 shows a first view of how various components of a humidity control system may be mounted in a cavity at the bottom of the display case.

FIG. 8 shows a second view of how various components of a humidity control system may be mounted in a cavity at the bottom of the display case.

FIG. 9 shows how the display panel for the humidity control system and a water fill-up tube may be disposed behind a first drawer facade.

FIG. 10 shows how a light control may be disposed behind a second drawer facade.

FIG. 11 shows, for one embodiment of the disclosed display case, a detailed view of a register set against a mirrored back panel.

### DETAILED DESCRIPTION OF THE EMBODIMENTS

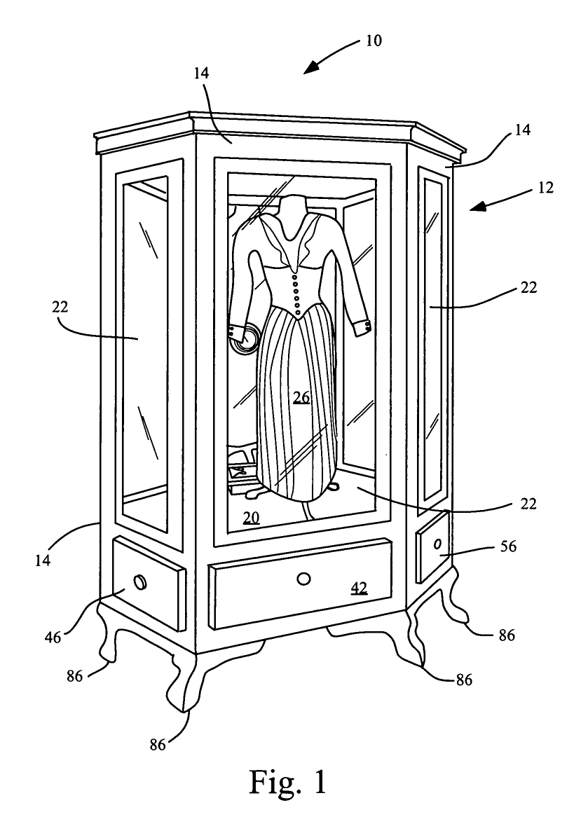

Referring now specifically to the drawings, FIG. 1 generally shows an embodiment of the display case 10. The display case 10 comprises an enclosing frame 12 or enclosure comprising a plurality of panels 14. The display case 10 further comprises an enclosing top 16 and enclosing bottom 18. The display case 10 may further comprise a floor 20. Some of the panels 14 may comprise glass sections 22, allowing a viewer to see into the interior of the display case 10. At least one of the panels 14 is hingedly attached to the enclosing frame 12 to allow access into the interior of the display case 10.

A dress form 24 is disposed within the display case 10. An article of clothing 26, such as gown, is placed upon the dress form 24. As shown in FIG. 1, the dress form 24 is sized to fit the article of clothing 26 in the shoulders, breast and abdomen portions of the garment. The dress form 24 may be shaped in human form, generally conforming to the shape of the shoulders, chest, abdomen, and hips of the wearer of the clothing article. The base of the dress form 24 may rest upon floor 20. As shown in FIG. 1, the enclosing frame is sufficiently large to allow enclosing a gown 26 upon the dress form 24 without the gown touching the interior sides of the panels 14.

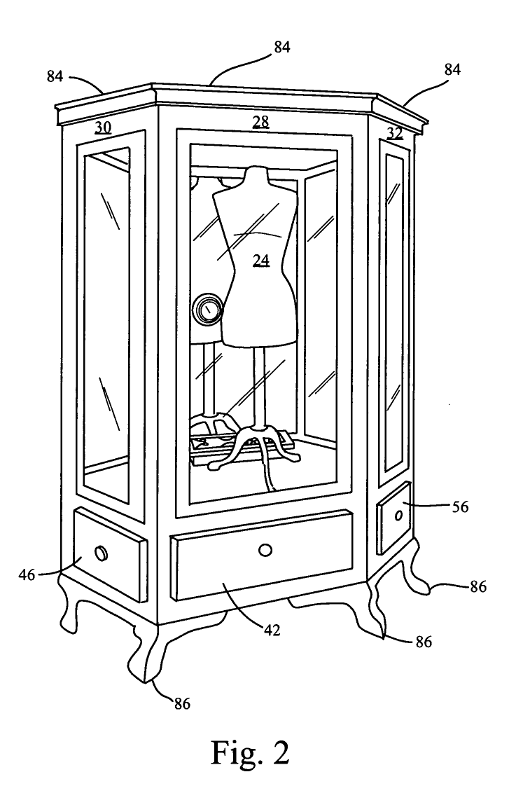

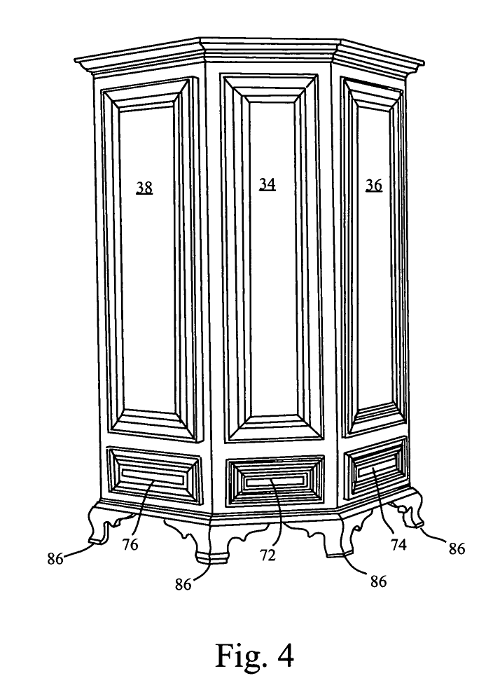

As shown in FIGS. 1 through 5, the display case 10 may be hexagonal in shape. As shown in FIG. 2, the front of the display case 10 may comprise a center front panel 28, a left front panel 30, and a right front panel 32. As shown in FIG. 4, the back of the display case may comprise a center back panel 34, a left (viewed from the front) back panel 36, and a right back panel 38, where the left back panel 36 adjoins the left front panel 30 and the right back panel 38 adjoins the right front panel 32.

Some of the panels 14 comprise glass sections 22 allowing a viewer to observe the clothing article 26 within the display case 10. As shown in FIG. 1, one embodiment of the display case 10 utilizes glass sections 22 in the center front panel 28, the left front panel 30 and the right front panel 32. The glass sections 22 may be beveled to increase the beauty of the display case. In addition, the glass sections 22 may comprise a clear film which blocks out a substantial amount of the exterior ultraviolet light, which may damage fabrics. In addition, the clear film will help hold the glass section together if it is broken.

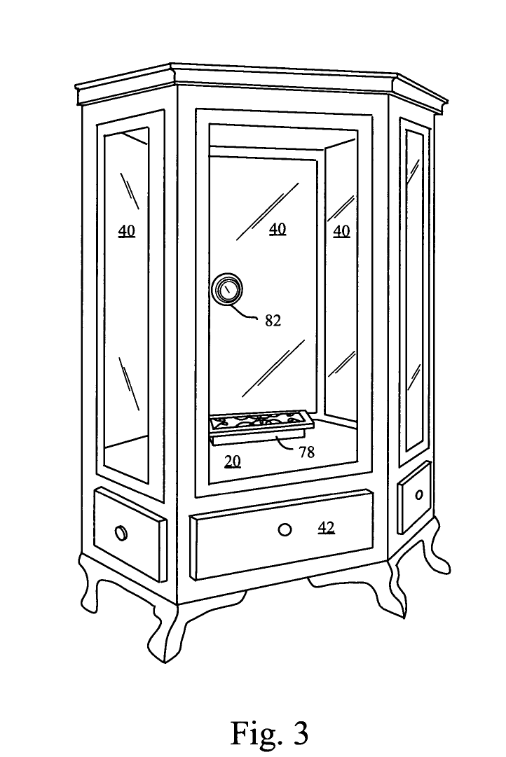

As shown in FIG. 4, rather than having glass sections 22, some of the panels 14 may be solid. Mirrors 40 may be attached on the interior side of the panels 14. For example, as shown in FIGS. 3 and 4, the center back panel 34, the left back panel 36 and the right back panel 38 may comprise solid panels to which mirrors 40 are fastened or attached on the interior sides. If the display case 10 is hexagonal in shape, as shown in FIGS. 1 through 5, the mirrored surfaces on the rear panels provide a complete view of the back and sides of the clothing article 26 to an observer standing at the front of the display case 10.

As best shown in FIGS. 1 through 5, in one hexagonal configuration, the panels may be configured such that center back panel 34 is not as wide as the opposite facing center front panel 28, the left back panel 36 is wider than the adjoining left front panel 30, and the right back panel 38 is wider than the adjoining right front panel 32. For symmetry, left back panel 36 and the right back panel 38 may have the same dimensions and left front panel 30 and right front panel 32 may have the same dimensions. This configuration makes this embodiment of the display case 10 narrower at the back than at the front, which facilitates placement of the display case in a corner or against a narrow wall, while simultaneously providing a wide viewing area from the front.

Front center panel 28, which may be hingedly attached to the enclosing frame 12 to allow access into the interior of the display case 10, may have antique brass hinges and skeleton key door lock and handle. Glass sections 22 may be beveled and have a clear UV coated safety film which will block out 98% of UV rays and will help hold the glass together if it is broken.

Display case 10 may further comprise a center drawer 42. This drawer may be dovetailed and have solid hardware. The interior of the drawer 42 may be padded and satin lined. The front of the center drawer 42 may be a five-piece raised panel with an antique brass pull. Center drawer 42 may be mounted on soft-close, full extension, under-mount slides 44.

Displace case 10 may further comprise left front drawer front 46. The left drawer front 46 may be a five-piece raised panel which matches the detail of the front of center drawer 42. As shown in FIG. 9, left drawer front 46 may be hinged at the bottom and configured to open from the top. When left drawer front 46 is pulled open, it may provide access to control panel 48. Control panel 48 may comprise the end of fill tube 50 which is used for providing water for water reservoir 52 shown in FIG. 7. Water reservoir 52 is one of the components of the humidity control system described below. Control panel 48 also comprises status indicators for the humidity control system, such as light emitting diodes 54, which may be used to indicate whether the humidity control system has power, whether the water level in water reservoir 52 is low, or whether wicking pads need to be replaced. Sensor 55 detects when the water level in reservoir 52 drops below two prongs which extend into the reservoir. When the water level drops below the two prongs it breaks the circuit and the low water light comes on.

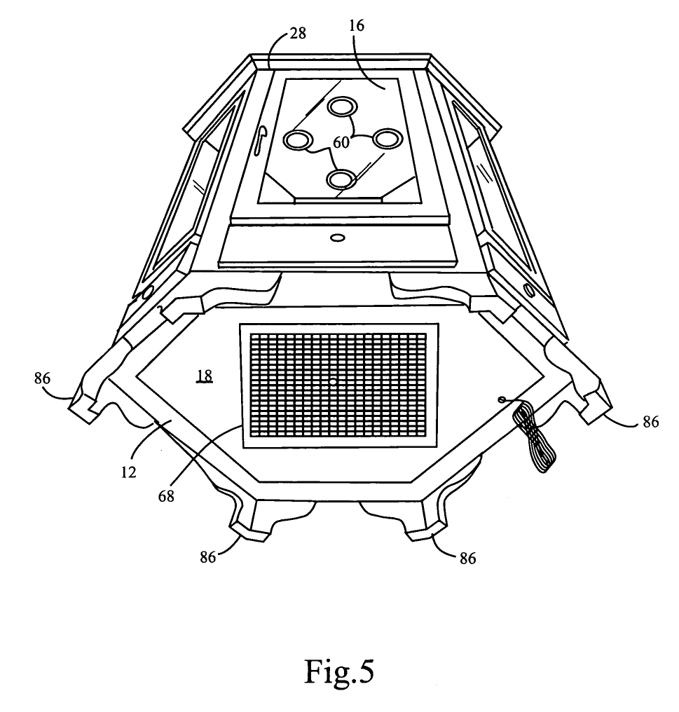

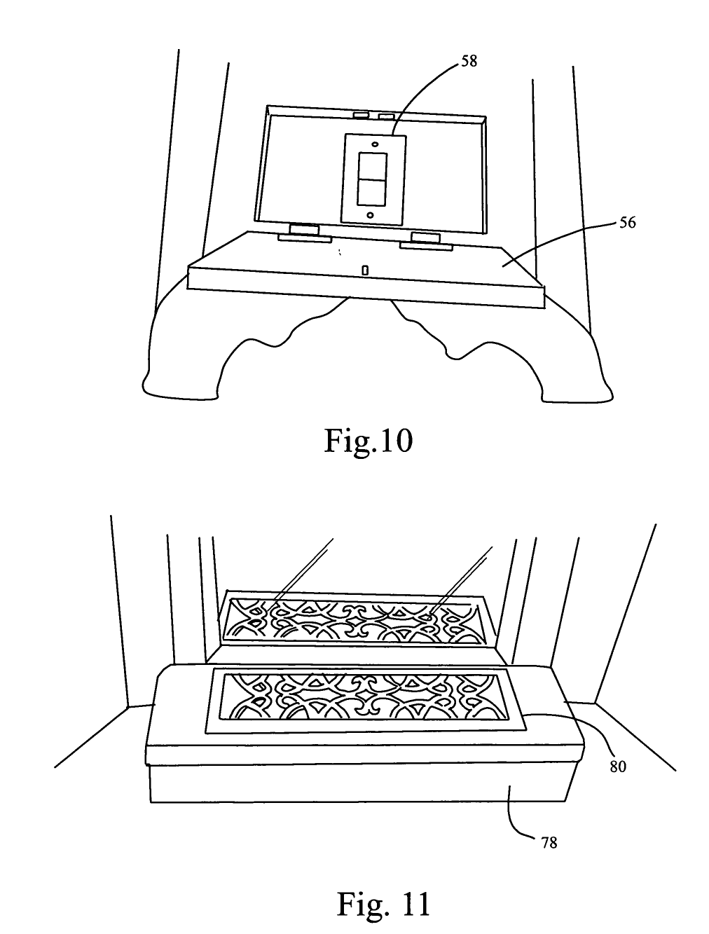

Display case 10 may further comprise a right drawer front 56. The right drawer front 56 may be a five-piece raised panel which matches the detail of the front of center drawer 42 and left drawer front 46. As shown in FIG. 10, right drawer front 56 may be hinged at the bottom and configured to open from the top. When right drawer front 56 is pulled open, it may provide access to light control 58. Light control 58 activates light means 60 which are shown in FIG. 5. Light means 60 may comprise low level museum quality lighting to protect fabric from ultraviolet radiation. An acceptable light means 60 comprises an LED cluster available through LEDTRONICS, Inc. The cluster, which is installed in a conventional light fixture, comprises forty light emitting diodes per cluster. This cluster creates almost no heat and emits no ultraviolet radiation. Light control 58 may further comprise an automatic timer for activating and deactivating the light means 60. If lighting is used, the lights may be installed such that the bulbs may be changed from the exterior of top 16 of the display case 10, where glass dividers separate the bulbs from the interior of the case. The inside of the light recesses may be detailed with antique brass rings 3 to 4 inches in diameter located inside the case.

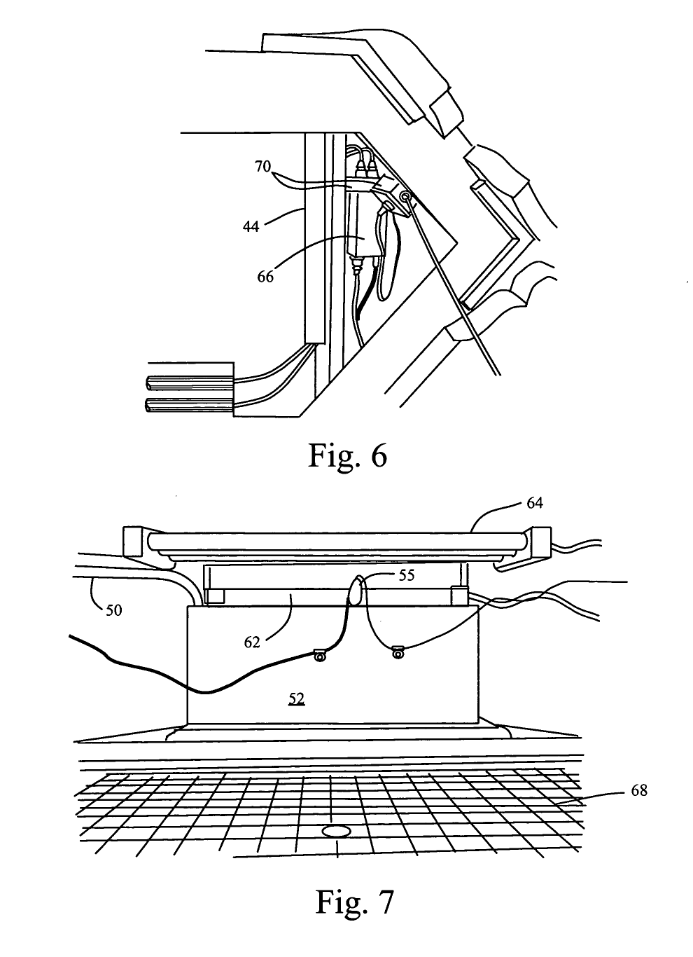

FIGS. 6 through 8 show the components of a humidity control system which may be utilized in the disclosed display case 10. Acceptable humidity control systems are available through DAMPP CHASER of Hendersonville, N.C. The components of the system comprise the water reservoir 52, humidifier 62, dehumidifying rods 64, and humidistat 66. The humidifier comprises wicking pads and a humidifying rod which provides a low level of heat. The humidistat 66 is calibrated to maintain a narrow range of humidity within display case 10. When the humidity falls below a particular preset value, the humidistat 66 activates humidifier 62, which increases humidity to an acceptable range. When the humidity increases above a particular preset value, the humidistat 66 activates dehumidifying rods 64. The humidity within the display case 10 will optimally be maintained in a range of 40 to 50 percent to provide an environment which is tolerated by the fabrics of the clothing articles displayed within the display case.

The humidity control system is disposed in the cavity created between enclosing bottom 18 and floor 20. As shown in FIG. 5, bottom 18 comprises an electrostatic air filter 68. The electrostatic filter 68 may be configured such that it may be removed through the opening in which center drawer 42 is disposed. Center drawer 42 is removed and the electrostatic air filter 68 may be pulled upwards for removal. It is to be appreciated that, for the benefit of the fabric of the article of clothing 26, there is air circulation through the display case 10. Components of the humidity control system, such as the dehumidifying rods 64, will create a slight temperature differential, causing a slight and generally upward air flow through the electrostatic air filter 68. Front center panel 28, or whichever panel 10 is used to provide access into the display case 10, is not a sealed door, thereby allowing air circulation through the case with air exiting at the access panel. It is to be appreciated that an electrical fan may also be disposed within the display case 10 to provide additional air circulation if desired.

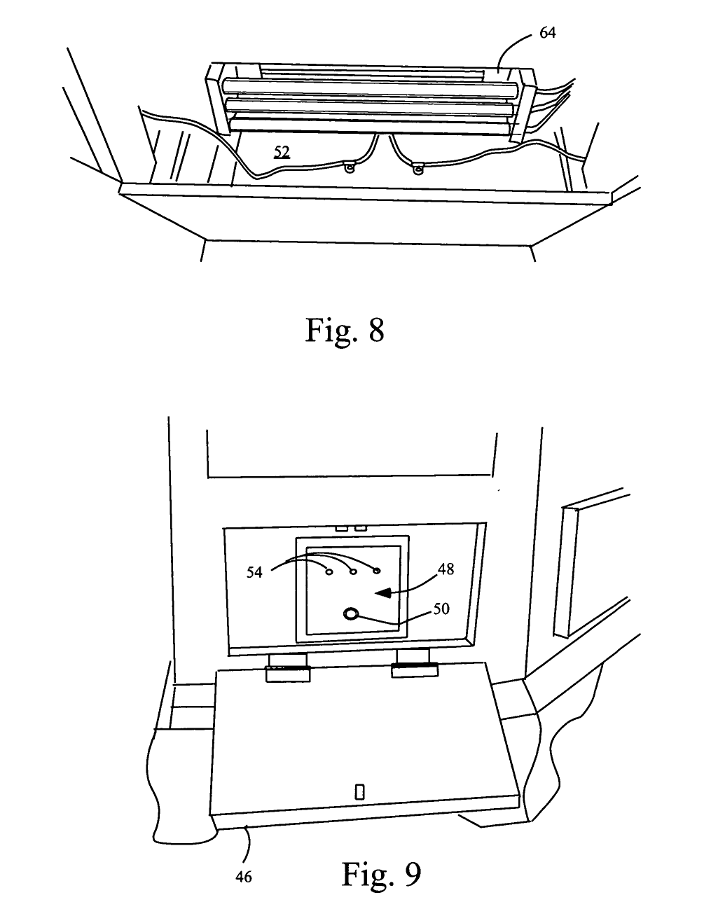

FIG. 6 shows how humidistat 66 and electrical junction boxes 70 may be disposed in the side of the cavity of display case 10. FIG. 7 shows a view of the lower cavity of the display case 10 through the opening in which center drawer 42 is disposed. As indicated by FIG. 7, access to the humidity control components may be gained by removing center drawer 42. FIG. 8 shows a view of the dehumidifying rods 64 with a portion of bottom 18 removed.

As shown in FIG. 4, the back side of an embodiment of the disclosed display case 10 may comprise a back center panel 34, a left back panel 36, and a right back panel 38. The back side may further comprise a center back drawer front 72, a left back drawer front 74, and a right back drawer front 76. The center back drawer front 72 may have a five piece raised panel drawer front which matches the detail of center drawer 42. Center back drawer front 72 may be hinged at the bottom and may open downwardly to provide access to the humidifier 62. Left back drawer front 74 and right back drawer front 76 may each comprise a five piece raised panel drawer front which match center back drawer front 72.

FIG. 2 and FIG. 3 indicate various components which may be included in the interior of an embodiment of the disclosed display case 10. Dress form 24 is disposed within the display case 10. As discussed above, the back center panel 34, the left back panel 36, and the right back panel 38, may each comprise a mirror 40 or mirrored panel to allow a viewer positioned at the front of the display case 10 to observe the back and back sides of the clothing article contained within the display case. In addition, the interior may further comprise box 78 which is disposed upon floor 20. Box 78, which may be fabricated from wood, with the box abutting the interior side of back center panel 34. As shown in FIG. 11, a brass register 80 may be disposed within the box 78 to allow air flow for the humidity controls discussed above. The register cover may be flush mounted against the top of the box. The box 78 may be padded and satin lined to enhance its appearance. If a circulation fan is desired, it may be located within box 78.

Hygrometer 82 may also be mounted within the interior of the display case to provide a the current humidity level inside display case 10. In keeping with the design and style of the display case, hygrometer 82 may be analog, have brass trim, and be approximately 3½ inches to 4 inches in diameter.

Crown molding 84 may be placed around the outer top of the display case 10. As shown in FIGS. 1 through 5, an embodiment of the display case 10 may further comprise legs 86. If the configuration of the display case 10 is that shown in FIGS. 1 through 5, a total of six legs may be used, where four of the legs are constructed in a 45 degree angle configuration and two of the legs are constructed in a 90 degree configuration.

While the above is a description of various embodiments of the present invention, further modifications may be employed without departing from the spirit and scope of the present invention. For example, the size, shape, and/or material of the various components may be changed as desired. Thus the scope of the invention should not be limited by the specific structures disclosed. Instead the true scope of the invention should be determined by the following claims.

What is claimed is:

1. A display case for displaying a clothing article, the display case comprising:
a frame,
a plurality of panels attached to the frame with one or more of the panels comprising a glass section and one of the panels hingedly attached to the frame;
an enclosing top affixed to the top of the frame;
an enclosing bottom affixed to the bottom of the frame;
a floor surface contained within the display case, wherein a cavity is defined by the space between the floor surface and the enclosing bottom;
a dress form disposed upon the floor surface; and
humidity control means within the cavity.

2. The display case of claim 1 further comprising lighting means for illuminating the interior of the display case.

3. The display case of claim 1 wherein the display case is hexagonal in shape.

4. The display case of claim 3 comprising a center front panel, a left front panel, a right front panel, a center back panel, a left back panel, and a right back panel.

5. The display case of claim 4 wherein the width of the center front panel is greater than the width of the center back panel.

6. The display case of claim 4 wherein the widths of the left front panel and the right front panel are respectively less than the widths of the left back panel and the right back panel.

7. The display case of claim 4 wherein the center front panel, the left front panel, and the right front panel each comprise a beveled glass section.

8. The display case of claim 4 wherein the center back panel, the left back panel and the right back panel each comprise a mirror on the interior side of the display case.

9. The display case of claim 1 wherein the humidity control means comprises dehumidifying rods for decreasing humidity, a humidifier for increasing humidity, and a humidistat for activating or deactivating the dehumidifying rods and the humidifier.

10. The display case of claim 1 further comprising a box disposed on the floor surface, wherein the box comprises a register to provide air flow from the humidity control means.

11. A display case for displaying a clothing article, the display case in a hexagonal shape, the display case comprising:
a center front panel, a left front panel, a right front panel, a center back panel, a left back panel, and a right back panel, wherein at least one of the panels comprises a glass section and at least one of the panels opens to provide access to the interior of the display case;
an enclosing top affixed to the tops of the center front panel, the left front panel, the right front panel, the center back panel, the left back panel, and the right back panel;
an enclosing bottom affixed to the bottoms of the center front panel, the left front panel, the right front panel, the center back panel, the left back panel, and the right back panel;
a floor surface disposed above the enclosing bottom, wherein a cavity is defined between the enclosing bottom and the floor surface;
a dress form disposed upon the floor surface; and
humidity control means contained within the cavity.

12. The display case of claim 11 wherein the width of the center front panel is greater than the width of the center back panel.

13. The display case of claim 12 wherein the widths of the left front panel and the right front panel are respectively less than the widths of the left back panel and the right back panel.

14. The display case of claim 11 further comprising lighting means for illuminating the interior of the display case.

15. The display case of claim 11 wherein the center front panel, the left front panel, and the right front panel each comprise a beveled glass section.

16. The display case of claim 11 wherein the center back panel, the left back panel and the right back panel each comprise a mirror on the interior side of the display case.

17. The display case of claim 11 wherein the humidity control means comprises dehumidifying rods for decreasing humidity, a humidifier for increasing humidity, and a humidistat for activating or deactivating the dehumidifying rods and the humidifier.

18. The display case of claim 11 further comprising a box disposed on the floor surface, wherein the box comprises a register to provide air flow from the humidity control means.

19. The display case of claim 18 further comprising one or more hinged drawer fronts, wherein a control panel is disposed behind one of the drawer fronts.

20. A display case for displaying a clothing article, the display case in a hexagonal shape, the display case comprising:
an interior space defined by a center front panel, a left front panel, a right front panel, a center back panel, a left back panel, and a right back panel, wherein the width of the center front panel is greater than the width of the center back panel and the widths of the left front panel and the right front panel are respectively less than the widths of the left back panel and the right back panel, wherein at least one of the panels comprises a glass section for viewing the interior space and wherein at least one of the panels opens to provide access to the interior space;
a top enclosing the interior space;
a bottom enclosing the interior space;
a floor surface disposed above the enclosing bottom, wherein a cavity is defined between the enclosing bottom and the floor surface;
a dress form disposed upon the floor surface;
lighting means for illuminating the interior of the display case; and
humidity control means contained within the cavity, wherein the humidity control means comprises dehumidifying rods for decreasing humidity, a humidifier for increasing humidity, and a humidistat for activating or deactivating the dehumidifying rods and the humidifier.
